(19) United States
(12) Patent Application Publication
(10) Pub. No.: US 2019/0111363 A1
(43) Pub. Date: Apr. 18, 2019

(54) A FILTER INSERT AND A FILTER ARRANGEMENT

(71) Applicant: VOLVO TRUCK CORPORATION, S-405 08 Goteborg (SE)

(72) Inventor: Anders HEDMAN, Marstrand (SE)

(73) Assignee: VOLVO TRUCK CORPORATION, S-405 08 Goteborg (SE)

(21) Appl. No.: 15/759,503

(22) PCT Filed: Sep. 23, 2015
(86) PCT No.: PCT/EP2015/071884

§ 371 Date: Mar. 12, 2018

(51) Int. Cl. B01D 29/96; B01D 29/21; B01D 35/00

(52) U.S. Cl. CPC B01D 29/96; B01D 29/21; B01D 35/005; B01D 2201/4076; B01D 2201/304; B01D 2201/4092; B01D 2201/291

(57) ABSTRACT

A filter insert is provided for being removably arranged in a compartment in a filter housing, which filter housing has a filter insert access opening which is adapted for being opened and closed, respectively, via a filter housing counterpart, wherein the filter insert includes a filter material body, a first end panel arranged on a first side of the filter material body, wherein the first end panel includes an arrangement for sealing engagement with the filter housing counterpart, and at least care recess formed in a radially outer peripheral surface for engagement with a radially inwards extending projection of the lifter housing, which when engaged rotationally lock the filter insert from rotation relative to the filter housing during attachment of the filter housing counterpart relative to the filter housing.

### BACKGROUND AND SUMMARY

The invention relates to a filter insert and a filter arrangement for cleaning a fluid. More specifically, the filter arrangement is adapted for cleaning a fluid for an internal combustion engine, wherein the fluid may be a liquid such as a lubricating oil or fuel or a gas such as air. Such filter arrangements may be provided onboard vehicles and in other applications containing transport systems to remove unwanted solids or other contaminants from the fluid. The filter insert may alternatively be called filter cartridge, filter module or filter element.

The filter insert comprises a filter material body, which may be in the form of a cylindrical structure of folded paper defining air inner space. The filter insert may further comprise a first end panel arranged on a first side of the filter material body and a second end panel arranged on a second side of the filter material body.

The filter arrangement comprises a filter housing, which may be non-removably attached to the internal combustion engine. The filter housing may be cup-shaped with an upper open, access end for receipt of the filter insert in an internal compartment. The filter housing encompasses at least one inlet fir raw fluid to be filtered, which empties into a raw side of the filter housing compartment, and an outlet, which starts at a clean side of the filter housing compartment, for filtered clean fluid. The filter insert is arranged to be cross-flowed in a radial manner by the fluid. The inlet and outlet may be provided in a lower portion of the filter housing. The filter housing defines a longitudinal axis, along which the filter insert can be inserted into the filter housing and removed from it. The filter arrangement further comprises a removable lid for closing the open end of the filter housing during operation. The filter housing and the lid are normally provided with complimentary Shaped threads for a rotational attachment of the lid to the filter housing. The lid may alternatively be called cover or cap.

The first and second end panels of the filter insert may be adapted for an axial sealing engagement relative to a bottom end wall of the filter housing and the lid, respectively. In some designs, the filter insert may need a compressive preload in order to seal off the internal side from the external side. The compressive preload may be obtained by means of rotationally engaging the threads of the lid with the threads of the filter housing. When the lid is rotated, the filter insert will be subjected to torsion in addition to the compressive force due to friction between the sealing means of the end panels relative to the filter housing end wall and the lid. This may lead to instability (buckling) of the filter insert paper structure.

The invention can be applied in an internal combustion engine, such as a diesel engine, for heavy-duty vehicles, such as trucks, buses and construction equipment. Although the invention will be described with respect to a diesel engine for a truck, the invention is not restricted to this particular application, but may also be used in other types of engines and for other types of vehicles, such as passenger cars. Further, the filter arrangement will be described below in an application for filtering oil, but may be used also in other applications for filtering other fluids.

It is desirable to provide a filter insert, which creates conditions for avoiding collapse of the filter material body (filter media or paper) via twisting during installation and also avoiding use of non-intended low quality filter inserts.

According to an aspect of the invention, a filter insert is provided for being removably arranged in a compartment in a filter housing, which filter housing has a filter insert access opening which is adapted for being opened and closed, respectively, via a filter housing counterpart, wherein the filter insert comprises

a filter material body,

a first end panel arranged on a first side of the filter material body, wherein the first end panel comprises a means for sealing engagement with the filter housing counterpart,

characterized in that

the first, end panel comprises at least one recess formed in a radially outer peripheral surface for engagement with a radially inwards extending projection of the filter housing, which when engaged rotationally lock the filter insert from rotation relative to the filter housing during attachment of the filter housing counterpart relative to the filter housing.

The rotational interlocking arrangement allows for torque transmission from the filter housing counterpart (for example a lid) to the filter housing solely via the first end panel of the filter insert. In other words, there will be no torque transmitted through the filter material body. This insight creates conditions for a new filter insert design, which may be more cost-efficient for example in that the filter paper does not have to be designed for withstanding the friction torque. Further, no central column in the filter insert adapted for support against buckling during insertion may be required. Further, the sealing arrangement between a lower portion of the filter insert and the adjacent bottom end wall of the filter housing may not necessarily be rotationally symmetrically designed.

According to one example, the filter insert access opening is adapted to be closed via a rotational attachment of the filter housing counterpart. By having a rotational locking connection between the first filter end panel and the filter housing, the filter material body will be relieved of torsion during the rotational engagement of the filter housing counterpart relative to the filter housing. The filter housing counterpart may be formed by a hand-manoeuvrable lid. According to one example, the sealing arrangement is located in an axial way, and therefor need the torque to compress a sealing ring to get a firm, leakfree sealing of the oil filter installation.

The invention is especially advantageous when the filter insert is adapted to engage with the filter housing at a second end of the filter insert in a way forming a frictional resistance against movement of the filter insert, for example when the filter insert is provided with a second end panel at the second side of the filter insert, opposite the first end panel, and wherein the second end panel is adapted to engage with an end wall of the filter housing, for example sealing and subjecting the sealing to a compressive force.

Further, by embodying the rotational locking means via at least one recess on the filter insert in the manner described above, use of a correct type of filter insert during filter insert exchange may be secured in that the corresponding radial projection from the filter housing obstructs insertion of filter inserts not being provided with the recess.

According to a further example, the filter housing counterpart sealing engagement means is adapted for achieving a sealing effect upon compression, wherein a frictional resistance is gradually increasing with further rotation of the lid.

The wording that the recess is formed in a “radially outer peripheral surface” is with regard to a central axis of the filter insert. In other words, the recess is open radially outwards and extends radially inwards from the outer periphery of the first end panel.

According to a further example, the first end panel comprises a plurality of circumferentially spaced recesses. The first end panel may comprise a plurality of circumferentially equally spaced recesses and according to one alternative two oppositely arranged recesses. Such a symmetric distribution of the recesses creates conditions for a lower contact load.

According to a further example, the recess is overlapping a peripheral boundary of the filter material body in the axial direction. For a folded paper structure, the recess may be positioned between two adjacent walls of the folded paper structure, which creates conditions for a space-efficient construction, avoiding any negative impact on filtration capacity.

According to a further example, the filter housing projection is complimentary shaped to the recess for a tight fit thereby avoiding any circumferential relative movements. According to a further example, the radial projection of the filter housing is provided in a side wall of the filter housing and especially projecting from a surface defining the compartment.

According to a further example, the rotational interlocking arrangement is adapted for blocking relative rotation during at least a final part of the attachment movement for attaching the filter housing counterpart to the housing (when the filter insert is compressed and there is sealing contact simultaneously between the filter insert and the filter housing counterpart and between the filter insert and a bottom end wall of the filter housing).

According to a further example, the first end panel is in contact with and preferably rigidly attached to the filter material body.

According to a further example, the filter housing is arranged in an upright position, wherein the filter insert access opening is directed upwards, wherein the first end panel defines an upper end of the filter insert in an operative position of the filter insert in the filter housing compartment.

According to further example, the filter housing is stationary (rigidly attached to the ICE) with the filter insert access opening facing upwards, ie upright position.

According to one example, the filter housing counterpart is formed by a lid moveable relative to a stationary filter housing and for ease of presentation, the invention will be described below for that example. However, the invention is not limited to that example and the filter housing counterpart may instead be formed by a stationary filter head, wherein the filter housing forms the moveable part. According to a further example, the lid has a ring-shaped collar provided with threads either on a radially inwards facing surface or on a radially outwards facing surface.

According to a further example, the recess forming the rotational locking means in the first end panel is adapted to allow a linear movement of the filter insert via guiding relative to the projection during the rotational attachment of the filter housing counterpart (lid) to the filter housing.

According to a further example, the filter material body has a cylindrical shape. The term “cylindrical shape” defines a volume enclosed by two planes perpendicular to an axis extending in an axial direction of the filter insert. The cross section of the cylinder perpendicular to the axis is preferably circular forming a right circular cylinder. The filter material body may be hollow-cylindrical and formed by a folded structure. However, the filter material body may be non-cylindrical, for example the volume may not be defined by two planes perpendicular to an axis. The axially limiting portions of the filter material body may be planes, but at least one of them may be non-perpendicular in relation to said axis. Further, at least one of the axially limiting portions of the filter material body may have a shape deviating from a straight plane, such as curved. The filter material body may be formed by a folded structure, such as a folded strip of cellulose material.

According to a further example, the first end panel has a main extension in a direction transverse to an axial direction of the filter insert. The first end panel is preferably configured to give a rigid support to the filter insert. The first end panel may have a plate shaped structure. Preferably, the first end panel is attached to one end of the filter material body. The first end panel may be formed by a separate unit, such as a paper or plastic disc, attached to the filer material body. Alternatively, the filter material body support structure may be formed by attaching a glue or other substance to an end of the filter material body. The substance attached may dissolve an end portion of the filter material body, which is then solidified, so that the filter material body support structure is partly made up of an end portion of the filter material body. This may for example be the case where the filter material body is formed by a folded paper.

According to one embodiment example, the filter housing counterpart sealing engagement means and the recess are arranged separate from one another on the first end cap. It is especially in the context that the filter housing counterpart sealing engagement means is distant from the recess (for example provided centrally with regard to a filter insert central axis) that the provision of the recess in the radially outer peripheral surface is advantageous for avoiding torque transmission through the filter material body.

According to a further embodiment example, the filter insert is adapted for allowing relative rotation to the filter housing counterpart during engagement and disengagement, respectively, of the filter housing counterpart sealing engagement means, The frictional resistance of the sealing arrangements will of course gradually limit the relative rotation when the filter insert is subjected to a compressive force between the end wall of the filter housing and the filter housing counterpart when the filter housing counterpart is threaded onto the filter housing, or vice versa.

According to a further embodiment example, the filter housing counterpart sealing engagement means is rotationally symmetric and arranged in a central position of the first end panel. This design creates conditions for a relative rotational movement for axially compressing the sealing arrangement during installation. Especially, the filter housing counterpart sealing engagement means has a circular cross sectional shape. Further especially, the filter housing counterpart sealing engagement means may be formed by an opening or a protruding portion centering around a central/longitudinal axis of the filter insert. According to one alternative, the filter housing counterpart sealing engagement means of the first end panel is formed by an opening and the filter housing counterpart is formed by a complimentary shaped protruding portion, preferably with a taper ng shape in a center axis direction for guidance of the filter insert to a correct operational position and for achieving a proper sealing function. More specifically, the protruding portion may be conical. According to one example, the sealing effect is achieved in that the protruding portion is formed by a flexible material, such as rubber.

According to a further embodiment example, the first end panel is rigidly attached to the filter material body. According to one example, the first end panel has an outer periphery defining a circular shape. According to a further example, the first end panel is plate-shaped. According to a further example, the circular outer periphery of the first end panel has a diameter equal to a diameter of the filter material body or somewhat larger than the diameter of the filter material body.

According to a further embodiment example, the filter material body is formed by a folded structure. The structure may be folded around a central axis forming a hollow cylindrical shape, wherein the folds are directed in parallel with the central axis and the inner folds end at a distance from the axis. According to one example, the recess is located circumferentially between adjacent folds of the folded structure. More specifically, the recess may be designed to extend between consecutive folds in a circumferential direction of the filter insert.

According to a further embodiment example, the filter insert comprises

a second end panel arranged on a second side of the filter material body opposite the first end panel,

wherein the second end panel comprises a means for sealing engagement with a bottom end wall of the filter housing.

According to one example, the filter housing sealing engagement means is adapted for flowing relative movement to the filter housing and more specifically to a bottom end wall of the filter housing during a linear movement of the filter insert towards its operative position.

According to one example, the second end panel defines a lower end of the filter insert in an operative position in the filter housing. According to one example, the second end panel is adapted to face a bottom end wall in the filter housing in its operative position, wherein the bottom end wall is positioned opposite the filter insert access opening.

According to one example, the bottom end wall engagement means in the second end panel is formed by an opening or protruding portion with a rotational symmetrical sectional shape, wherein the bottom end wall of the filter housing is provided with the other of the opening and protruding portion for achieving a sealing engagement during operation. More specifically, the opening or protruding portion has a circular cross sectional shape. According to one example, the opening or protruding portion extends around a central/longitudinal axis of the filter insert and is centered around the central/longitudinal axis. At least, one of the engaging opening and protruding portion has a tapering shape in the direction of the central/longitudinal axis. According to one alternative, the filter housing sealing engagement means of the first end panel is formed by an opening and the filter housing is formed by a complimentary shaped protruding portion, preferably with a tapering shape in a center axis direction for guidance of the filter insert to a correct operational position and for achieving a proper sealing function. More specifically, the protruding portion may be conical. According to one example, the sealing effect is achieved in that the protruding portion is formed by a flexible material, such as rubber. Providing both end panels of the filter insert with similar sealing means creates conditions for an axially symmetric filter insert design, wherein the filter insert may be positioned in the filter housing compartment with either of the first and second end panel facing the lid.

According to a further embodiment example, the second end panel is rigidly attached to the filter material body and wherein there is no internal tubular support structure interconnecting the first end panel and the second end panel functioning for transferring a torque between the end panels. According to one example, the first end panel and the second end panel are interconnected only via the filter material body. Alternatively, there may be an internal tubular support structure functioning as a protection against collapse due to a too high pressure difference between an inside and an outside of the filter material body during operation.

According to a further embodiment example, the second end panel is provided with at least one recess formed in a radially outer peripheral surface arranged for movement of the second end panel passed the radial projection of the filter housing during insertion and withdrawal, respectively of the filter insert relative to the filter housing compartment. Providing, both end panels of the filter insert with similar recesses creates conditions for an axially symmetric filter insert design, wherein the filter insert may he positioned in the filter housing compartment with either of the first and second end panel facing the lid. According to one example, the recesses of the first end panel and the second end panel overlap in an axial direction of the filter insert. In other words, the recesses of the first end panel and the second end panel are circumferentially matched so that they overlap in an axial direction of the filter insert.

According to one example, the filter insert may comprise a means for guiding the projection from an inner wall of the filter housing between the recesses of the first end panel and the second end panel during insertion and withdrawal of the filter insert relative to the filter housing. Said guiding means may be formed by a separate guiding channel member attached between the first end panel and the second end panel or by a channel defined in or by the filter material body, such as by two adjacent walls of the folded paper structure.

It is also desirable to provide a filter arrangement, which creates conditions for avoiding collapse of the filter material body (filter media or paper) via twisting during installation and also avoiding use of non-intended low quality filter inserts.

According to an aspect of the invention, a filter arrangement is provided comprising a filter housing with a compartment and an access opening for receipt of a removable filter insert and a filter housing counterpart, which is adapted for opening and closing, respectively, the filter insert access opening of the filter housing, wherein the filter housing counterpart and the filter housing comprise means complimentary shaped for attachment of the filter housing counterpart to the filter housing via a relative rotational movement.

According to one example, the filter housing is stationary. In the application of filtering a fluid for an ICE, the tiller housing may be rigidly attached to the ICE. According to one example, the filter housing is arranged so that the filter insert access opening faces upwards, ie the filter housing would be in an upright position. The filter housing counterpart would then be formed by a lid, preferably a hand-manouvrable lid.

According to one embodiment example, the complimentary shaped attachment means is formed by a threaded structure. Said lid may then have a ring-shaped collar provided with threads either on a radially inwards facing surface or on a radially outwards facing surface for engagement with complimentary shaped threads on the side wall of the filter housing.

According to one embodiment example, one of the first end panel of the filter insert and the filter housing counterpart has an opening and the other one of the first end panel of the filter insert and the filter housing counterpart has a protruding portion, wherein the opening and protruding portion are complimentary shaped for said sealing engagement during attachment of the filter housing counterpart to the filter housing. According to one example, the opening and protruding portion are rotationally symmetrically arranged around a central axis of the filter insert and filter housing counterpart, respectively.

According to one embodiment example, at least one of the opening and the protruding portion has a tapering shape for a gradually increasing resistance towards a rotational movement during attachment of the filter housing counterpart to the filter housing.

According to a further embodiment example, the filter housing counterpart forms a lid, which is adapted for being maneuvered by hand relative to the filter housing.

According to a further embodiment example, one of the second end panel of the filter insert and a bottom end wall of the filter housing has an opening and the other one of the second end wall of the filter insert and the bottom end wall of the filter housing has a protruding portion, wherein the opening and protruding portion are complimentary shaped for sealing engagement during the rotational attachment of the filter housing counterpart to the filter housing.

According to a further embodiment example, at least one of the opening and the protruding portion has a tapering shape for a gradually increasing resistance towards a rotational movement during said attachment of the filter housing counterpart to the housing.

According to a further example, the filter insert and filter arrangement, respectively, is adapted for filtering a fluid, such as oil, fuel or air, for an internal combustion engine.

Further, the invention is directed towards an internal, combustion engine system comprising an internal combustion engine and a filter arrangement according to any one of the embodiment examples described above operatively connected to the internal combustion engine for filtering a fluid for the internal combustion engine.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 discloses a vehicle in the form of a truck in a side view,

FIG. 2 discloses an internal combustion engine of the truck in a perspective view with a filter arrangement attached,

FIG. 3 discloses the filter arrangement of FIG. 2 in a partly assembled state,

FIG. 4 is a perspective view from the top of a filter insert according to a first embodiment example,

FIG. 5 is a perspective view from below of the filter insert, according to the first embodiment example,

FIG. 6 is an exploded view of the filter insert of FIGS. 4-5,

FIG. 7 is a perspective view from the top of a lid according to a first embodiment example,

FIG. 8 is a perspective view from below of the lid according to the first embodiment example,

FIG. 9 is a partially cut perspective view from the top of a filter housing according to a first embodiment example,

FIG. 10 is an exploded view of a filter arrangement according to a first embodiment example comprising the filter insert, lid and filter housing according to FIGS. 1-9,

FIG. 11 is a cross sectional view of the filter arrangement according to FIG. 10 in an operational state,

FIG. 12 is a perspective view from the top of a filter insert according to a second embodiment example, and

FIG. 13 is a perspective view from below of a filter insert according to a second embodiment example.

### DETAILED DESCRIPTION

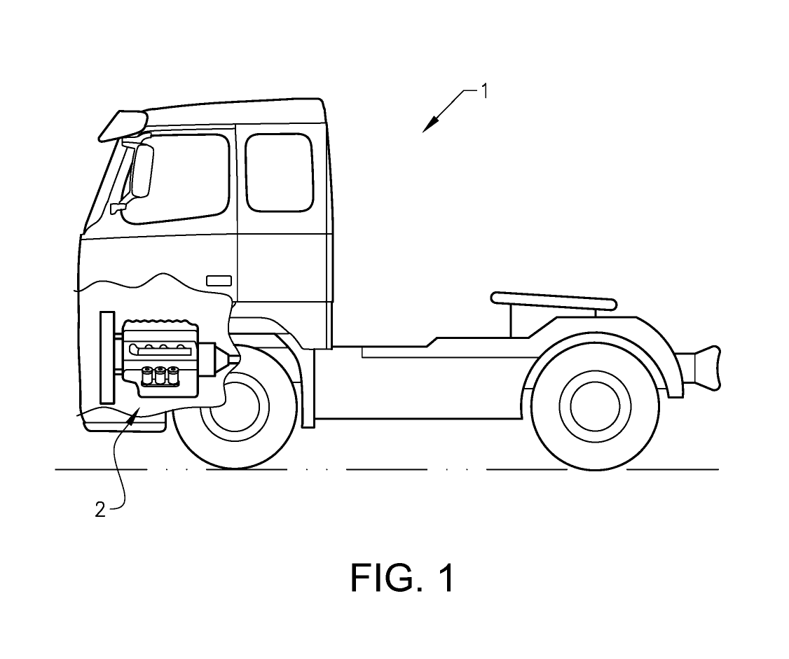

FIG. 1 discloses a vehicle in the form of a truck I in a partly cut side view, Further, an internal combustion engine, ICE, in the form of a diesel engine 2 is indicated.

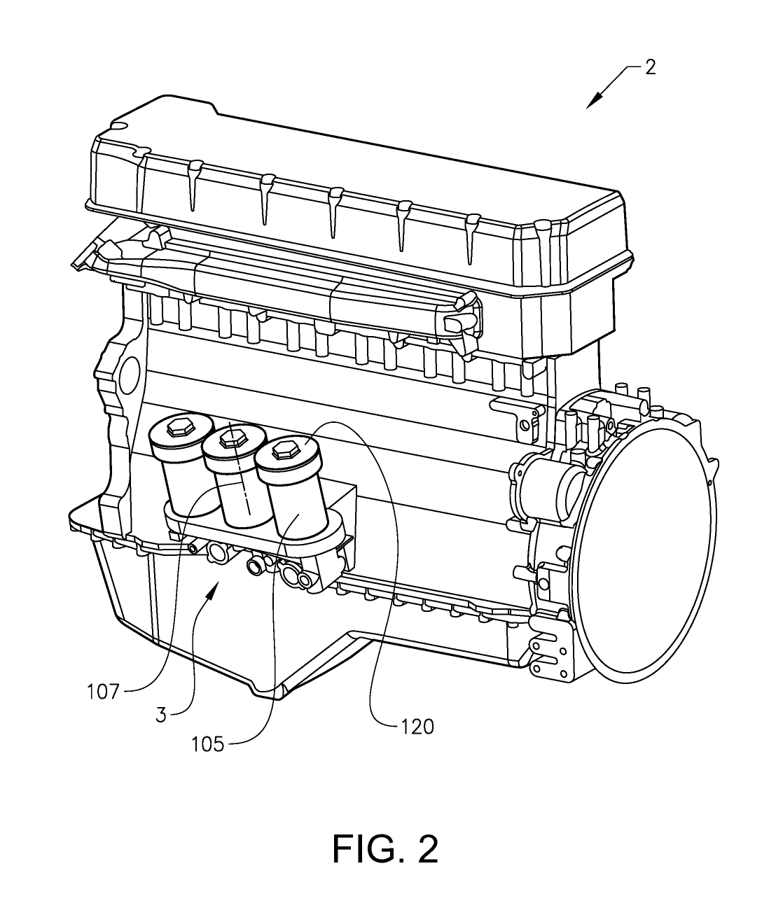

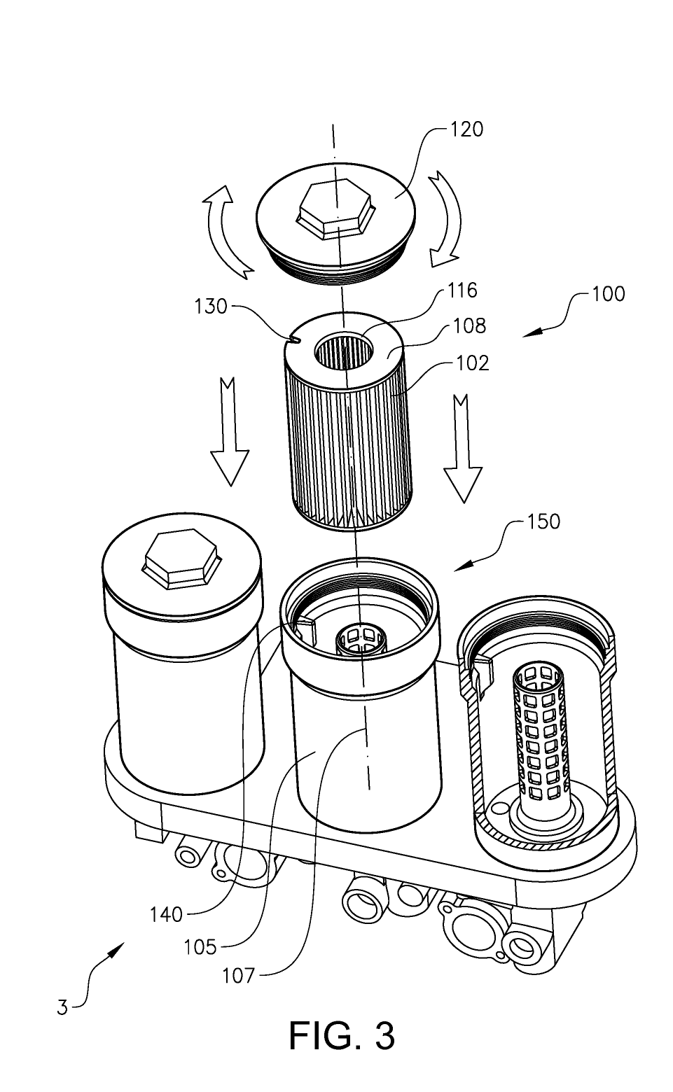

FIG. 2 shows the ICE 2 provided with a filter arrangement 3 according to a first embodiment of the invention. The filter arrangement 3 is adapted for filtering a fluid for the ICE. More specifically, there are three filter arrangements 3 arranged in parallel with each other. Other numbers of filter arrangements may of course also be feasible depending on space constraint and other reasons, such as a single filter arrangement or two filter arrangements. The filter arrangement 3 comprises a filter housing 105, which is attached to the ICE. The filter arrangement 3 is in an upright, standing position, slightly inclined outwards from its attachment at the bottom relative to a side of the ICE. A lower section of the filter arrangement comprises inlets and outlets, The filter housing 105 is in the form of a cup-shaped part, which is rigidly attached to the ICE at the lower section. The filter housing 105 defines a longitudinal center axis 107 along which a filter insert (not shown) can be inserted into the filter housing and removed from the filter housing via an access opening 150, see FIG. 3. The filter arrangement 3 further comprises a filter housing counterpart 120 in the form of a lid for closing the filter housing. For ease of presentation, the filter housing counterpart will in the following be referred to as a lid 120.

FIG. 3 discloses the filter arrangement 3 of FIG. 2 in a partly assembled state. A filter insert 100 according to a first embodiment example is inserted into, the filter housing 105 via the access opening 150 via a first linear movement in parallel with the longitudinal axis 107. The lid 120 is then attached to the filter housing via a rotational movement around the longitudinal axis 107.

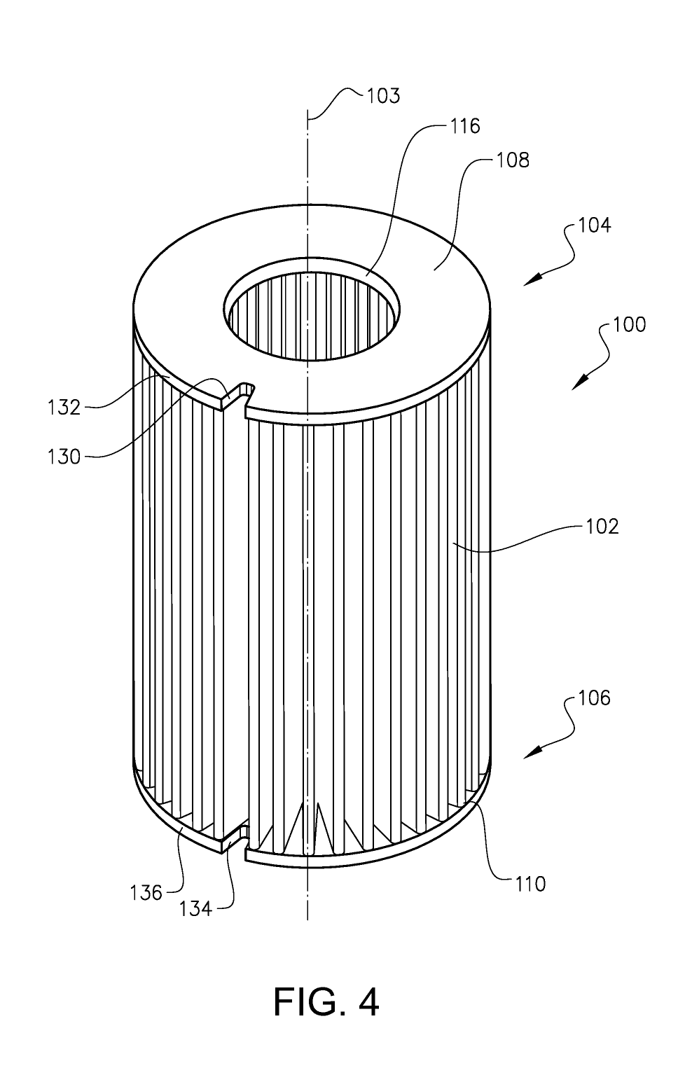

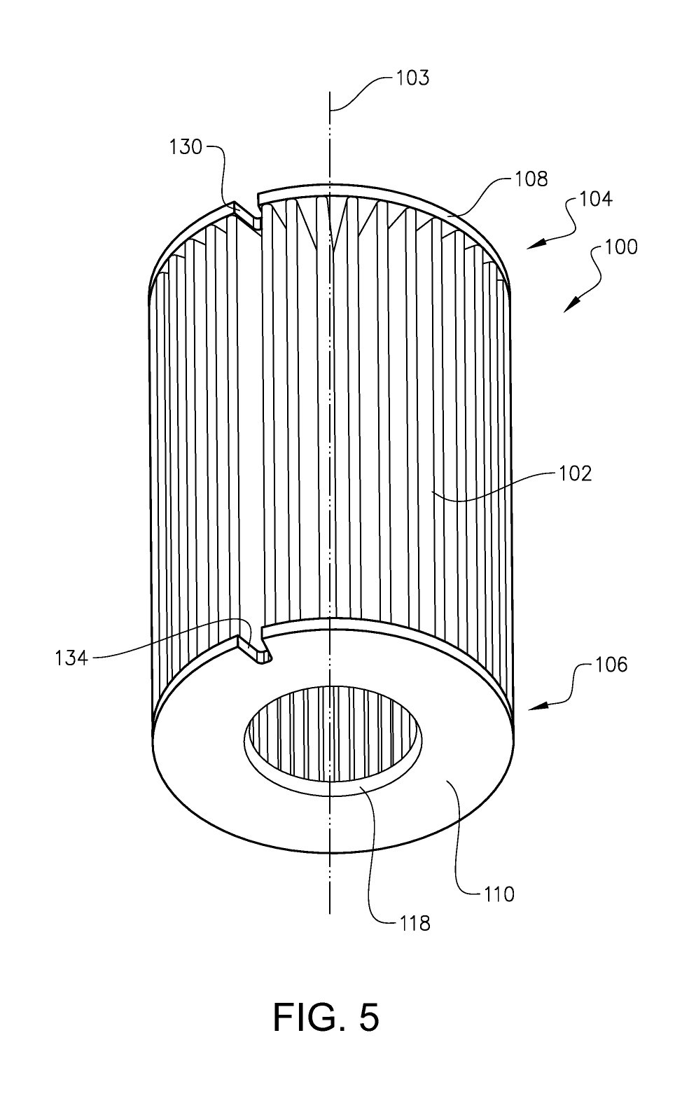

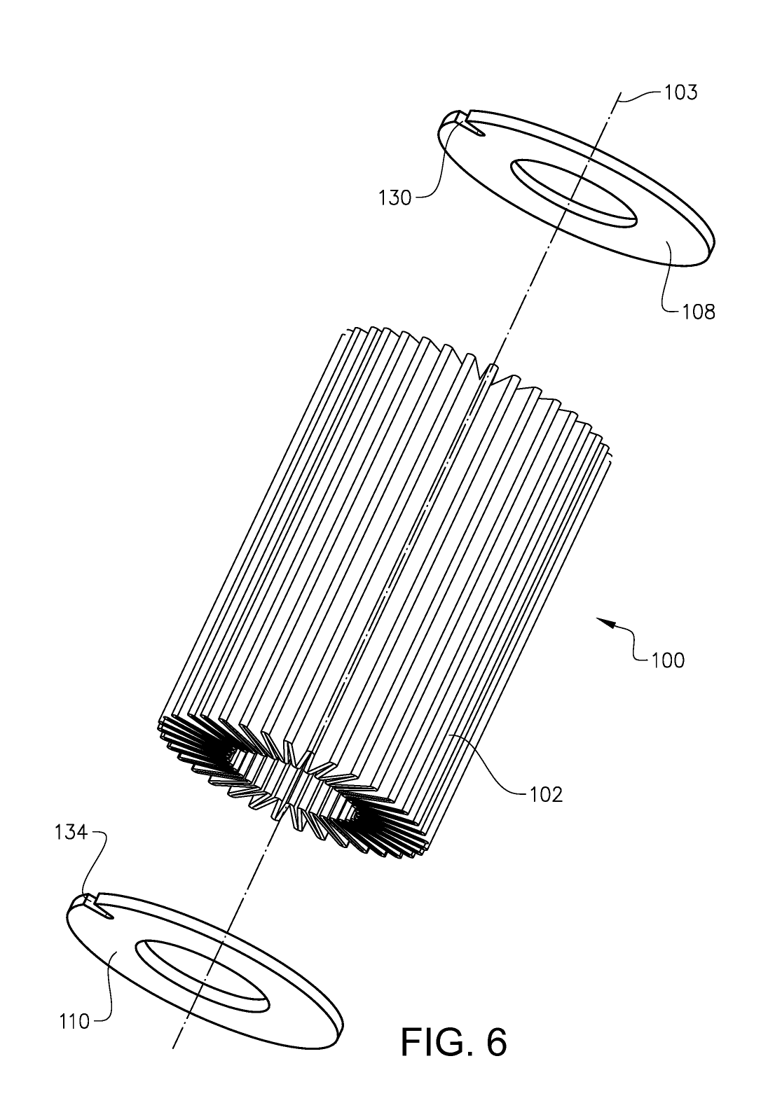

FIGS. 4-5 shows the filter insert 100 from FIG. 3 for being removably arranged in the filter housing 105. FIG. 6 is an exploded view of the filter insert of FIGS. 4-5.

The filter insert 100 comprises a filter material body 102. The filter material body 102 has a cylindrical shape. The cross section of the cylinder at right angles to the axis is circular forming a right circular cylinder. More specifically, the filter material body 102 is hollow cylindrical defining a central space. Further, the filter material body 102 is formed by a folded paper structure extending between the central space and a radially outer circumference of the filter insert. The filter insert 100 defines a first end 104 and a second end 106 opposite the first end.

The filter insert 100 comprises a first end panel 108 at the first end 104 and a second end panel 110 at the second end 106. Each end panel 108,110 has a main extension in a direction transverse to an axial direction 103 of the filter insert. More specifically, each end panel 108,110 has a plate shaped structure extending in a plane perpendicular to the axial direction 103 of the filter insert.

The filter material body 102 is delimited on the top by the upper, first end panel 108 and on the bottom by the lower, second end panel 110. The end panels 108,110 may be formed by separate parts attached to the filter material body 102. The filter material body 102 is then bonded to the upper end panel 108 and lower end panel 110 at the edges of the filter paper in the axial direction of the filter insert. Alternatively, the end panels 108,110 are formed by a glue or other fastening fluid attached to the edges of the filter material body 102 in the axial direction of the filter insert and then solidified.

The first end panel 108 comprises a means 116 for sealing engagement with the lid 120 in order to separate a raw side from a clean side of the filter arrangement. The sealing engagement means 116 is formed by an opening in the form of a through hole in the first end panel. The through-hole is in communication with the inner space in the hollow cylindrical filter material body. More specifically, the through-hole has a radial extension commensurate with a radial extension of the inner space in the hollow cylindrical filter material body. The filter insert 100 is adapted for allowing relative rotation of the lid 120 during engagement and disengagement, respectively, of the lid sealing engagement means 116. More specifically, when the lid 120 is in rotational engagement with the filter housing 105 and rotated, the filter insert 100 is increasingly compressed while the relative rotation takes place until the filter insert 100 reaches its operative position in the filter housing and the sealing means is compressed to a final state blocking any further relative rotation when the lid 120 has reached its final position. More specifically, the lid sealing engagement means 116 is rotationally symmetric and arranged in a central position of the first end panel 108 for creating conditions for said relative rotation.

In a similar manner, the second end panel 110 comprises a means 118 for sealing engagement with a bottom end wall of the filter housing 105 in order to separate a raw side from a clean side of the filter arrangement. The sealing engagement means 118 is formed by an opening in the form of a through hole in the second end panel. The through-hole is in communication with the inner space in the hollow cylindrical filter material body. More specifically, the through-hole has a radial extension commensurate with a radial extension of the inner space in the hollow cylindrical filter material body. Each of the openings 116,118 is circular around a centre point coinciding, with the central axis 103 of the filter insert.

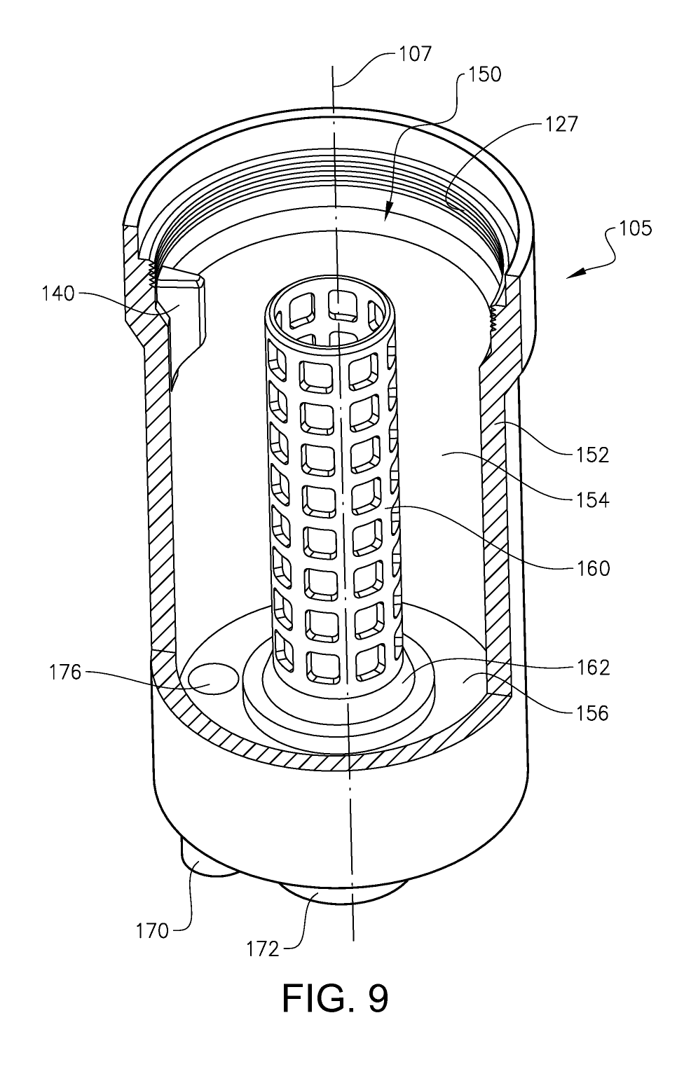

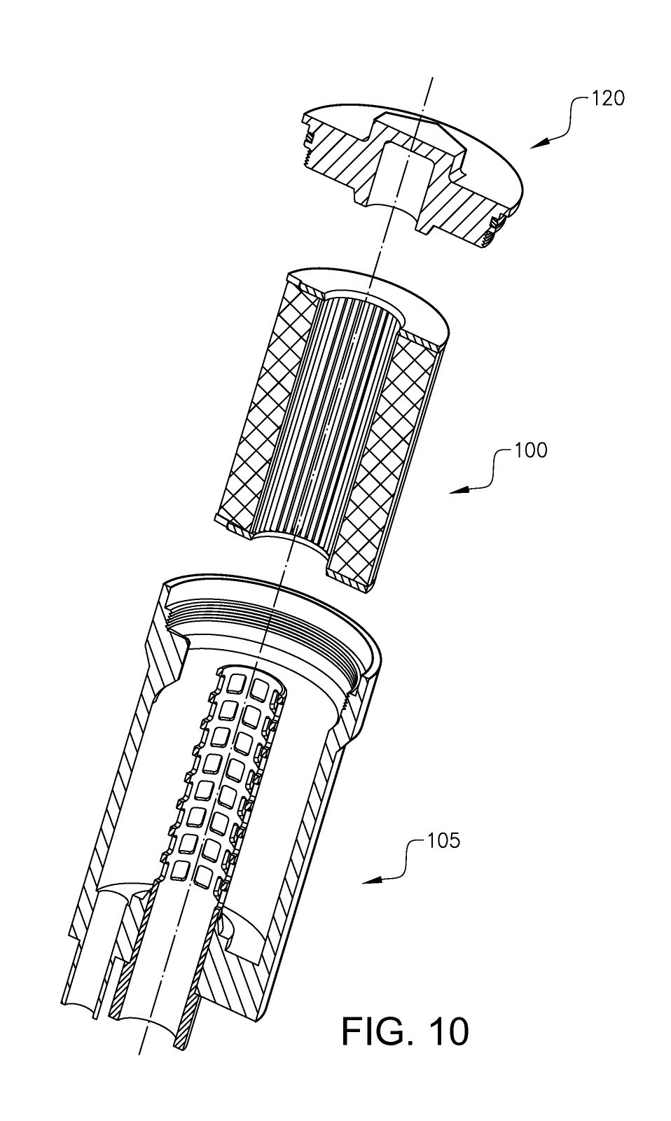

The first end panel 108 comprises at least one recess 130 formed in a radially outer peripheral surface 132 for engagement with a radially inwards extending projection 140 of the filter housing 105, see FIG. 9, which when engaged rotationally lock the filter insert 100 from rotation relative to the filter housing 105 during attachment of the lid 120 relative to the filter housing. The lid sealing engagement means 11 and the recess 130 are arranged separate from one another on the first end cap 108.

In a similar manner, the second end panel 110 comprises at least one recess 134 formed in a radially outer peripheral surface 136 for receipt of the projection 140 during insertion and removal of the filter insert 100 relative to the filter housing 105. The recess 134 in the second end panel 110 is in communication with the recess 130 in the first end panel 108 so that when the filter insert 100 is inserted in the housing 105 the projection enters first the recess 134 in the second end panel 110 and then ends up in the recess 130 in the first end panel 108 When the filter insert 100 reaches its operative position. The sealing means 118 and the recess 134 are arranged separate from one another on the second end cap 110.

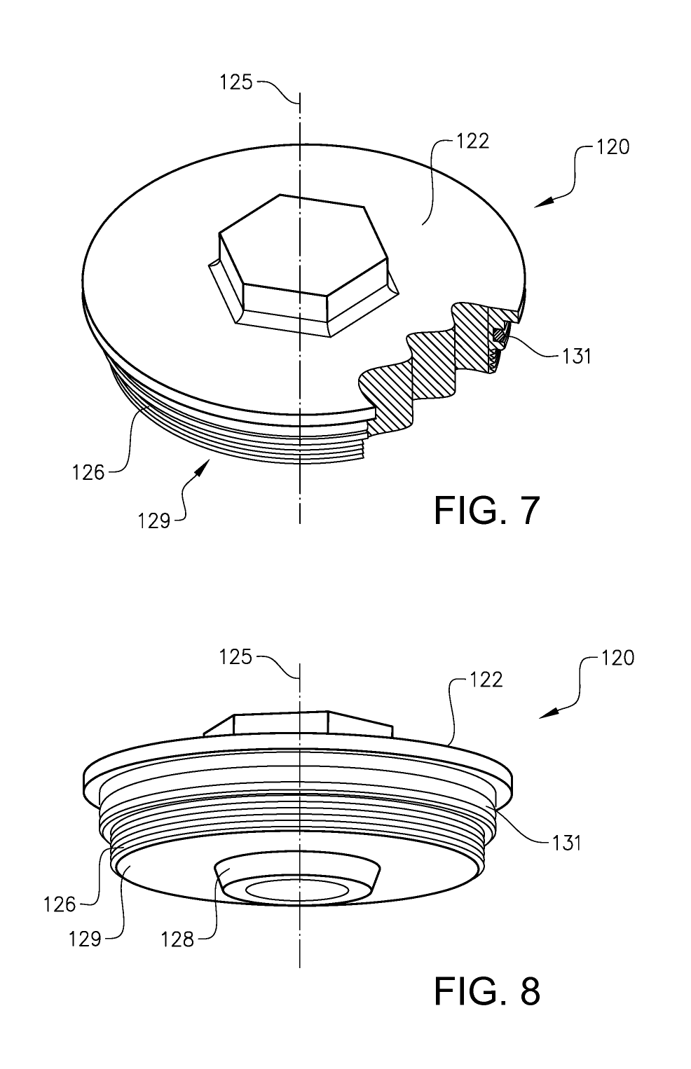

FIG. 7 and 8 are perspective views from the top and bottom, respectively, of the lid 120 according to a first embodiment example. The lid 120 comprises attachment means 126 complimentary shaped with attachment means 127 of the filter housing 105, see FIG. 9, for attachment of the lid 120 to the filter housing via a relative rotational movement. More specifically, the complimentary shaped attachment means 126 is formed by a threaded structure.

The lid 120 comprises a circular plate shaped member 122 and an annular part 129 in the form of a collar projecting from a first, lower side of the plate shaped portion 123, which part 129 is provided with the threads 126 on an external side. Further, the lid 120 comprises a sealing means 128 for sealing engagement with the sealing means 116 of the first end panel 108 of the filter insert 100. The sealing means 128 is formed by a circular projection extending from the lower side of the plate-shaped portion 123 and centered around a center axis 125 of the lid 120. The projection 128 is tapering in a direction away from the plate-shaped portion 123 and is conical. At least the external surface of the projection 128 is formed by a flexible material, such as rubber for achieving a sealing engagement to the filter insert 100 in an operative state. Further, a sealing ring 131 is provided on a radially external side of the collar and above the threads 126.

FIG. 9 shows the filter housing 105 according to a first embodiment example. The filter housing 105 has an access opening 150 for receipt of the filter insert 100 and wherein the filter housing lid 120 is arranged for opening and closing, respectively, the filter insert access opening 150. The filter housing 105 comprises a compartment 154 for the filter insert 100 defined by a cylindrical side wall 152.

The filter housing 105 comprises attachment means 127 in the form of threads complimentary shaped with the threads 126 of the lid 120 for attachment of the lid 120 to the filter housing via a relative rotational movement. Further, the filter housing 105 comprises a projection 140 projecting radially inwards from the circular wall 152. The projection is positioned at an upper section and more specifically in the vicinity of the access opening 150 for engagement with the recess 130 in the first end panel 108 of the filter insert when the filter insert 100 is actuated during the rotation of the lid during engagement of the threads. The shape and size of the radially extending projection 140 is matched to the to recess 130 in the first end panel 108 of the filter insert 100 and is preferably the same or somewhat smaller in size for a tight fit. According to one example, the recess 130 and the projection 140 have substantially the same shape in a cross section at right angles to the enter axis 103 of the filter insert 100 and the longitudinal axis 107 of the filter housing 105, respectively. Further, a diameter of the circular cylindrical wall 152 is matched to a diameter of the filter material body 102 establishing a gap between them.

The filter housing 105 has a central upstanding, tubular portion 160 for receipt in the central space of the filter insert 100. The central upstanding, tubular portion 160 extends from a bottom wall 156 of the filter housing 105. The tubular portion 160 is arranged to support the filter insert 100 against buckling during operation and guide the filter insert 100 to its correct operational position during insertion. Further, the sealing means is realized between the tubular portion 160 and the sealing means 118 of the filter insert 100. The tubular portion 160 forms a fluid permeable central post. Mere specifically, the central post 160 is grid-shaped.

Further, filter housing 105 comprises a sealing means 162 for sealing engagement with the sealing means 118 of the second end panel 110 of the filter insert 100. The sealing means 162 is formed by a circular projection extending from the bottom end wall 156 and centered around the longitudinal center axis 107. The projection 162 is tapering in a direction away from the bottom end wall 156 and is conical. An external surface of the projection 162 is formed by a metallic material, for achieving a sealing engagement relative to the end panel 110 of the filter insert 100 in an operative state. More specifically, the sealing means 162 forms a lower portion of the fluid permeable central post 160.

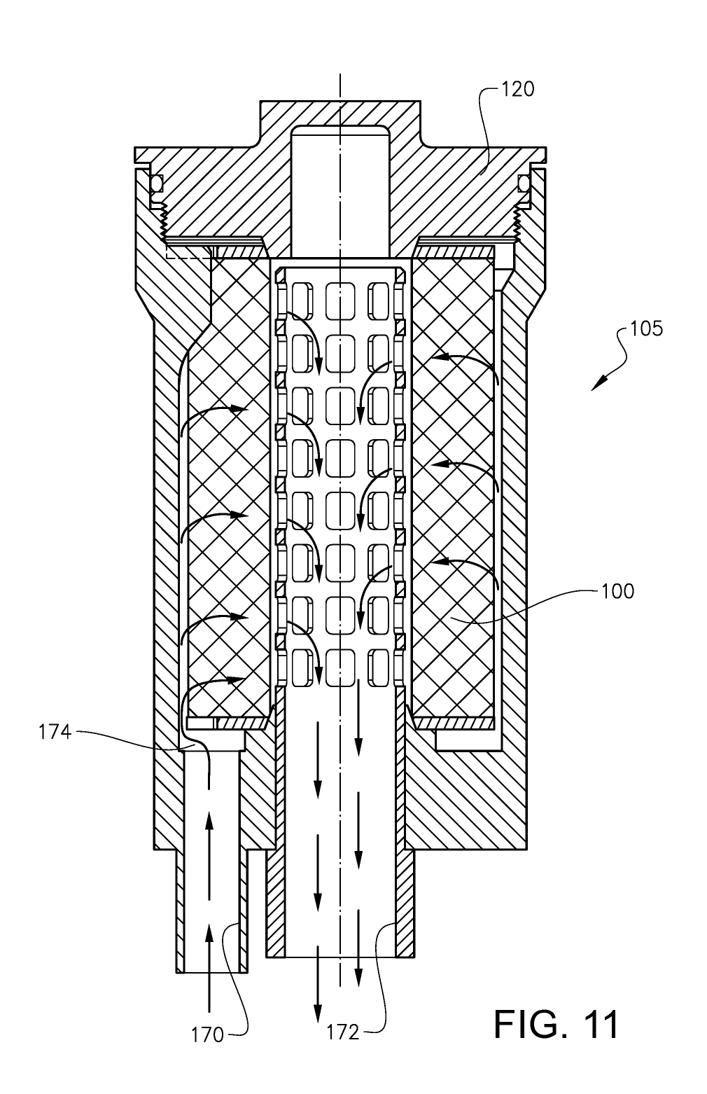

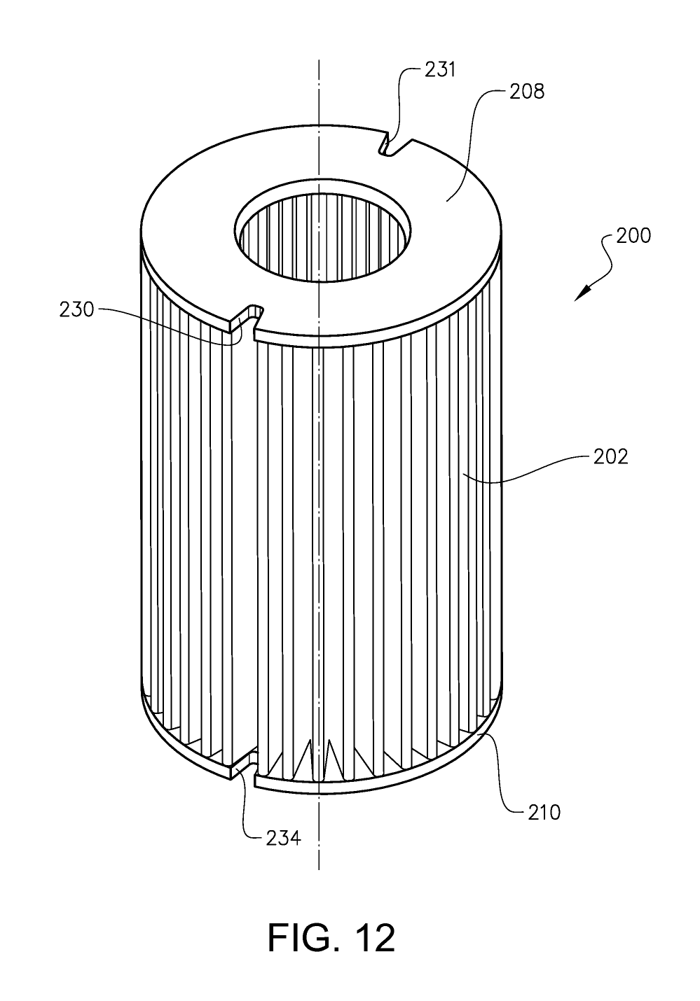

The filter housing 105 comprises an inlet 170 for receipt of a raw fluid to be filtered, which empties into a raw side of the filter housing, and an outlet or return 172, which starts at a clean side of the filter housing, for filtered clean fluid. The inlet 170 and outlet 172 are provided in a lower region 136 of the filter housing 105. The inlet 170 and outlet 172 are in communication with different sides of the filter material body 102. More specifically, the outlet 172 is provided in the bottom wall 156 of the filter housing and positioned radially centrally and adapted to match the position of the central opening in the tubular portion 160 so that it is in fluid communication with an interior side of the tubular portion 160. Further, the inlet 170 is positioned radially eccentric in the bottom wall 156 of the filter housing for distributing the fluid to a radially external side of the filter material body 102. The direction of the fluid inside the filter arrangement is disclosed in FIG. 11. Through the inlet 170, the fluid flows to a ring-shaped chamber 174 and further to a raw side of the filter housing (the radial gap between the filter insert 100 and the filter housing 105) via a plurality of circumferentially spaced openings 176. By flowing through the filter material body 102, the liquid flows to the clean side of the filter housing (the radially interior space). The filtered liquid flows off through the outlet (return) 172. Dirt particles are retained in the filter material body 102.

FIG. 11 is an exploded view of the filter arrangement according to the first embodiment example comprising the filter insert 100, lid 120 and filter housing 105.

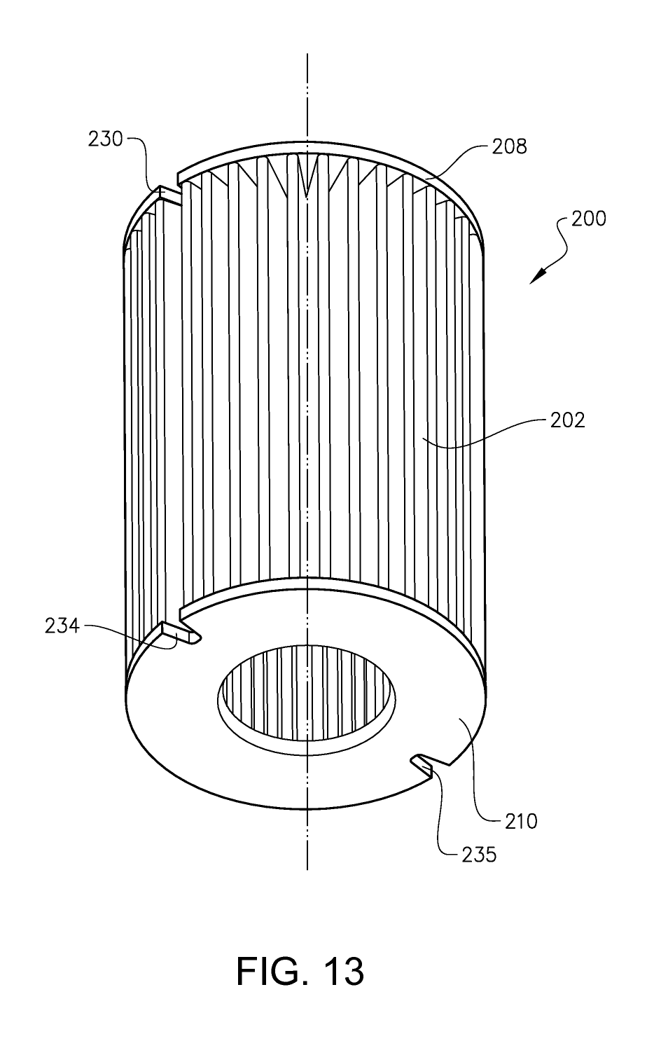

FIGS. 12-13 show a second embodiment example of a filter insert 200. The filter insert 200 comprises a filter material body 202 similar to the one described above for the first embodiment example. The filter insert 100 further comprises a first end panel 208 at a first end of the filter material body 202 and a second end panel 210 at a second end of the filter material body 202 also similar to what has been described above for the first embodiment example. The second embodiment example of the filter insert 200 differs from the first embodiment example in that there are a plurality of recesses 230,231 formed in a radially outer peripheral surface of the first end panel 208 for engagement with a complimentary shaped radially inwards extending projection of the filter housing. More specifically, there are two recesses 230,231 positioned opposite each other. In a similar manner, the second end panel comprises two recesses 234,235 positioned opposite each other. A filter housing should preferably have two opposite projections for engagement with the two recesses. This embodiment example is rotationally symmetric and creates conditions for lower contact load.

It is to be understood that the present invention is not limited to the embodiments described above and illustrated in the drawings; rather, the skilled person will recognize that many changes and modifications may be made within the scope of the appended claims.

According to one alternative, the filter arrangement may have a position relative to the ICE, which differs from an upright, standing position. For example, the filter arrangement may be positioned so that its longitudinal axis is substantially horizontal or even in a position, where the access end faces vertically downwards or in any inclined position between a horizontal and vertical position.

According to one alternative, the filter insert may comprise a central tubular structure positioned inside of the filter material body and in contact with an inner periphery of the filter material body for supporting the filter material body and reduce risk of collapsing of the filter material body. In the case the filter insert has a fluid permeable central tubular structure, the post 160 and the structure should be matched in design and/or rotational position for aligning the through holes allowing fluid through-flow. Alternatively, the filter housing may not have any central tubular structure at all. According to one alternative, the tubular structure for collapse protection in the filter insert may be removably attached to the filter insert for reuse with a new filter insert.

According to one alternative to that the inlet and outlet are provided in a lower region of the filter housing, the inlet and/or outlet may be arranged at any position along the filter housing in its longitudinal direction. For example, the inlet and/or outlet may be arranged through the cylindrical side wall of the filter housing. According to a further alternative, the filter housing may be designed with the inlet arranged centrally and the outlet arranged eccentrically, wherein the fluid flow through the filter material body would take place radially outwards instead of radially inwards as in the shown embodiment.

According to one alternative to that the filter housing is stationary and the lid is moveably arranged relative to the filter housing, the filter housing forms a pan moveable relative to a stationary filter head comprising the inlet and outlet for the fluid. For example, the filter arrangement may be designed so that filter housing has a closed lower end and is fastened at its open upper end to the filter head, wherein the filter housing will be in a hanging state.

According to a further alternative, the means 126,127 complimentary shaped for attachment of the filter housing counterpart 120 to the filter housing, via a relative rotational movement is not limited to a threaded structure. For example, such attachment means may be formed by a bayonet catch connection.

According to a further development, the housing or lid, depending on the orientation of the arrangement, may be provided with a drainage opening eccentrically positioned in the bottom end wall for draining out residual fluid when a used filter insert is removed, which drainage opening may be connected to a sump. Further, the filter insert may be provided with a drainage plug for engagement with the drainage opening for losing/opening the same. Such a drainage plug may be eccentrically arranged and projecting in an axial direction downwards from the second, lower end panel. By arranging the drainage opening in a set circumferential angular relation to the radial projection and arranging the drainage plug correspondingly circumferentially matched to the recess in the first, upper end panel, an automatic operation of the drainage may be achieved when the filter insert is removed.

According to a further development, the lid and the filter insert may be provided with engagement means for withdrawing the filter insert together with the lid when the lid is removed from the filter housing. Such a solution would lead to a more efficient filter insert exchange in that the lid and the filter insert would be removed from the filter housing via one single movement. Such engagement means may be provided via a snap connection, for example that one of the lid and filter insert is provided with axially projecting and radially flexible hooks and the other of the lid and filter insert is provided with at least one recess for receipt of the hooks. The snap connection would then be releasable for reuse of the lid with a new filter insert.

According to an alternative to that the central upstanding, tubular portion 160 is rigidly attached to a bottom portion of the filter housing 105, the tubular portion 160 may be removably connected to the housing. According to an alternative to that the filter housing 105 has a central upstanding, tubular portion 160 for receipt in the central space of the filter insert 100, it is instead the filter housing lid, which comprises a central tubular portion for receipt in the central space of the filter insert 100. The central tubular portion may be either rigidly attached to the lid or removably connected to the lid.

1. A filter insert for being removably arranged in a compartment in a filter housing, which filter housing has a filter insert access opening which is adapted for being opened and closed, respectively, via a filter housing counterpart, wherein the filter insert comprises
a filter material body,
a first end panel arranged on a first side of the filter material body, wherein the first end panel comprises a means for sealing engagement with the filter housing counterpart,
a second end panel arranged on a second side of the filter material body opposite the first end panel, wherein the second end panel comprises a means for sealing engagement with a bottom end wall of the filter housing, wherein
the first end panel comprises at least one recess formed in a radially outer peripheral surface for engagement with a radially inwards extending projection of the filter housing, for rotationally locking the filter insert relative the filter housing when in use, and the second end panel is provided with a recesses formed in a radially outer peripheral surface arranged for movement of the second end panel past the radial projection of the filter housing during insertion and withdrawal, respectively of the filter insert relative to the filter housing compartment.

2. A filter insert according to claim 1, wherein the filter housing counterpart sealing engagement means and the recess are arranged separate from one another on the first end panel.

3. A filter insert according to claim 1, wherein the filter housing counterpart sealing engagement means is rotationally symmetric and arranged in a central position of the first end panel.

4. A filter insert according to claim 1, wherein the filter housing counterpart sealing engagement means in the first end panel is formed by an opening or a protruding portion.

5. A filter insert according to claim 1, wherein the first end panel is rigidly attached to the filter material body.

6. A filter insert according to claim 1, wherein the filter material body is formed by a folded structure.

7. A filter insert according to claim 1, wherein the second end panel is rigidly attached to the filter material body and wherein there is no internal tubular support structure interconnecting the first end panel and the second end panel functioning for transferring a torque between the end panels.

8. A filter arrangement comprising a filter housing with a compartment and an access opening for receipt of a removable filter insert according to claim 1 and a filter housing counterpart, which is adapted for opening and closing, respectively, the filter insert access opening of the filter housing, wherein the filter housing counterpart and the filter housing comprise means complimentary shaped for attachment of the filter housing counterpart to the filter housing via a relative rotational movement.

9. A filter arrangement according to claim 8, Wherein the complimentary shaped attachment means is formed by a threaded structure.

10. A filter arrangement according to claim 8, wherein one of the first end panel of the filter insert and the filter housing counterpart has an opening and the other one of the first end panel of the filter insert and the filter housing counterpart has a protruding portion, wherein the opening and the protruding portion are complimentary shaped for the sealing engagement during attachment of the titter housing counterpart to the filter housing.

11. A filter arrangement according to claim 10, wherein at least one of the opening and the protruding portion has a tapering shape for a gradually increasing resistance towards a rotational movement during attachment of the filter housing counterpart to the filter housing.

12. A filter arrangement according to claim 8, wherein the filter housing counterpart forms a lid, which is adapted for being maneuvered by hand relative to the alter housing.

13. A filter arrangement according to claim 8, wherein one of the second end panel of the filter insert and a bottom end wall of the filter housing has an opening and the other one of the second end wall of the filter insert and the bottom end wall of the filter housing has a protruding portion, wherein the opening and the protruding portion are complimentary shaped for sealing engagement during the rotational attachment of the filter housing counterpart to the filter housing.

14. A filter arrangement according to claim 13, wherein at least one of the opening and the protruding portion has a tapering shape for a gradually increasing resistance towards a movement of the filter insert during the attachment of the filter housing counterpart to the housing.

15. An internal combustion engine system comprising an internal combustion engine and a filter arrangement according to claim 8 operatively connected to the internal combustion engine for filtering a fluid for the internal combustion engine.

16-18. (canceled)
